(19) United States
(12) Patent Application Publication
(10) Pub. No.: US 2018/0315143 A1
(43) Pub. Date: Nov. 1, 2018

(54) Digital Estate Planning Systems, Methods and Interfaces

(71) Applicant: DirectURWealth Inc., San Francisco, CA (US)

(72) Inventors: Amir Atashi Rang, San Francisco, CA (US); Amir S. Sarreshtehdary, Navato, CA (US); Amanda Ewing-Rice, Clayton, CA (US)

(21) Appl. No.: 15/963,965

(22) Filed: Apr. 26, 2018

Related U.S. Application Data
(60) Provisional application No. 62/491,636, filed on Apr. 28, 2017.

(51) Int. Cl. G06Q 50/18; G06N 5/04; H04L 9/06

(52) U.S. Cl. CPC G06Q 50/186; H04L 2209/38; H04L 9/0637; G06N 5/04

(57) ABSTRACT

Embodiments of the present invention are directed to computer implemented systems, methods and interfaces for creating a digital estate plan. One embodiment of the invention is directed towards computer readable storage media for automating a digital estate plan by providing a dynamic and graphical interface for populating information relevant for a user's will, trust, health directives and power of attorney, and executing an application to retrieve user identifying information and correlating user asset information into electronic fields of digital estate forms and third-party electronic financial institution forms. Other embodiments are directed towards methods of executing computer readable media to gather user identifying information and asset information and executing graphical user interfaces for recording user preferences for asset allocations and then parsing and correlating this information into databases and electronic documents to complete a legally viable estate plan. Other embodiments of the invention are directed towards using artificial intelligence for retrieving user asset information from third-party sources and directing and organizing this information into electronic databases and digital documents to effectuate an estate plan.

Aspects of the present disclosure relate to computer and software implemented systems, processes, computer readable media and novel computer user interfaces for automating an estate plan and electronically populating databases and electronic forms necessary to effectuate a complete estate plan. This application claims priority to provisional application No. 62/491,636 filed on Apr. 28, 2017.

### FIELD

### Background

The number of trusts and agency accounts are rising every year as people undertake more complicated wealth planning systems. Traditional estate planning is a tedious and form intensive process. A typical estate plan includes a trust, a will, a medical directive, and powers of attorney. A client who has several types of assets and who wishes to create a comprehensive estate plan, typically retains the services of an attorney. These assets include e.g., bank accounts, insurance/annuities, brokerage accounts, retirement accounts and real property. These assets must be accounted for in the trust and will documents in order to provide detailed instructions to a trustee or executor as to how property and assets should be marshalled, handled, or transferred during the life or after the death of the trustor, i.e., the person who creates the trust. In addition, many people wish to avoid the costly and time-consuming probate process; and comprehensive estate plans can do just that.

These plans, however, are not static. Beneficiaries often change and properties are added to or removed from the estate. Moreover, a complete set of estate documents does not effectuate: (a) the designation of beneficiaries (and agency relationships); and (b) ownership changes at the specific financial institutions or governmental agencies, where the individual or trust holds accounts or property. In many cases, these designations or forms are simply never filled out by a client/user creating an estate plan. To legally effectuate the transfer of assets and designate beneficiaries, the trustor must: (a) fill out forms at each of the user's financial institutions; (b) record deeds; or (c) make online designations at banks or brokerage accounts.

There is no uniform system to accomplish this process. There are thousands of financial institutions around the world and each has its own unique forms or websites to handle designations and ownership changes. The administrative costs of maintaining this process creates hard costs to the financial institutions resulting from creating, tracking, and storing this information. The information technology costs for maintaining and tracking this information across the computer systems of the various financial institutions is enormous. Financial costs are also an encumbrance to the user, in terms of time and opportunity costs. Additionally, probate costs can significantly impact an estate if the estate plan is not synchronized with the designations made by a user at his or her financial institutions, banks, insurance companies and/or governmental offices. These costs amount to billions of dollars every year and create a tremendous waste of resources and legal fees. For example, currently California and New York have over $21 billion in static money, sitting unclaimed with their respective Controllers' Offices.

Traditional websites such as Legal Zoom, Rocket Lawyer or Nolo do not provide services that allow a user to transact all the documentation necessary to create an effective estate plan and distribute assets to the intended beneficiaries. These sites do not electronically link with third parties to allow a user to make designations and changes at the user's individual accounts. Moreover, these solutions do not make efficient use of computer resources and have no ability to use artificial intelligence to capture user asset data and preferences to auto-populate or auto-correlate user identifying information into electronic databases and digital documents.

The use of cloud computing and distributed networks has also radically changed how vast quantities of electronic user information is captured, stored and accessed across networks. With online security, cryptography and authentication tasks, user's can safely store and access their data over decentralized and distributed networks. Blockchain is one example of a decentralized network that allows for documents and data to be securely distributed and accessed so that no one server holds all the pieces of the puzzle and the user's data (e.g., account and beneficiary information).

Therefore, what is required is a computer implemented and automated system of effectuating a secure digital estate plan that allows an end-user to: (1) create a simplified, streamlined and legally effective digital estate plan, (2) manage and track all of the electronic documentation necessary to create an effective digital estate plan, (3) make changes and designations to the digital estate plan across the individual's asset classes, including financial institutions, banks, insurance companies, brokerage houses, government offices, etc. and (4) maintain the user's digital estate planning documents in a secure network that can be electronically accessed by the user or his or her attorneys and agents to streamline the process of estate planning.

### BRIEF DESCRIPTION OF THE DRAWINGS

FIG. 1 is a diagram depicting one embodiment of the computer implemented estate planning system architecture.

FIG. 2 is a diagram illustrating one embodiment of a computer implemented estate planning system architecture with data and execution outputs.

FIG. 3 is a diagram conceptually illustrating an embodiment of the proper plan graphical user interface according to one embodiment.

FIG. 4 is a diagram conceptually illustrating one embodiment of the overview computer implemented system and process flow for a user to connect and transfer information between an estate planning server and third-party servers.

FIG. 5 is a diagram conceptually illustrating one embodiment of the control feature of the automated estate planning process.

FIG. 6 is a diagram conceptually illustrating one embodiment of the transfer feature of the automated estate planning process.

FIG. 7 is diagram conceptually illustrating one embodiment of the one document estate planning module.

FIG. 8 is a diagram conceptually illustrating one embodiment of execution module of the automated estate planning system.

FIG. 9 depicts an embodiment of the user database module of the automated estate planning system.

FIG. 10 depicts an embodiment of the review module of the automated estate planning system.

FIG. 11 depicts an embodiment of the tax and insurance modules of the automated estate planning system.

FIG. 12 depicts an embodiment of a computer implemented artificial intelligence method of retrieving user asset information for a digital estate plan.

FIG. 13 depicts an embodiment of a blockchain method of securely distributing and storing a digital estate plan.

FIG. 14 depicts an exemplary computer architecture on which the computer and software aspects of the systems, methods and computer readable media can operate according to the preferred embodiments of the invention.

### SUMMARY OF PREFERRED EMBODIMENTS OF THE INVENTION

An embodiment of the present invention includes computer and computer programmable and executable code to enable end-users to securely and effortlessly fill out, execute, and submit change of ownership forms and beneficiary designation forms for financial accounts; quickly set and globally manage all accounts at any financial institution with respect to: (1) who can access/control their accounts and when; (2) who should receive their assets and when (gift/inheritance); and (3) efficiently create a comprehensive estate plan (including living trust, will, power of attorney for finances, and medical directive) with one notarized signature (“one document only”, a proprietary process).

One embodiment of the invention includes a proper plan server which allows a user and creator of an estate plan to securely login over a network and communicate directly with third-party institutions such as banks, brokerage accounts, insurance companies, title companies and public records databases.

One embodiment of the invention includes computer programmable code that takes data from a user's input into various templates and uses trust, will, medical directive and power of attorney software modules to output forms and information necessary to generate a one-document estate plan with exhibits. One embodiment of the invention also includes a funding wizard software module which includes computer code to communicate with third-party institutions to retrieve forms or push a user's designations and other information necessary to populate third-party forms. One embodiment also uses computer code to pull information and forms from third parties.

One embodiment of the invention includes a proper plan website hosted at a web server which may be securely accessed by a user through a desktop, mobile or other computing platform. In one embodiment, the proper plan server features unique graphical user interfaces displaying various options for the user to select from such as overview options, resources, control, transfer, taxes, insurance, and review options. The user can also select from his or her brokerage accounts, liquid assets, retirement accounts, insurance/annuities, real property, business interests or other properties that may populate an estate pan. In one embodiment, the proper plan server is a one point gateway to allow the user to enter all necessary information related to his or her estate plan.

One embodiment of the invention includes programmable code and automatic or semiautomatic methods for a user to make designations such as beneficiaries and co-owners, which are then provided to or pulled by third-party institutions such as banks, brokerage accounts, insurance companies, title companies, and public records databases. In one embodiment, the proper plan server can electronically retrieve forms from these third parties and auto populate the forms with the user's designations and inputted information. In another embodiment, the information can be directly provided to the user-specific third parties where the forms can then be populated at the third-party sites.

One embodiment of the invention includes computer programmable code for allowing a user to make control designations. For example, designations during the user's lifetime or after death. The methods allow for electronic templates and process flows that allow the user to check boxes or make electronic designations such as co-owners, agents or trustees, designate beneficiaries for various properties, and name trustees or successor trustees. This information can be collected, processed, and stored at the proper plan server and provided to third-party institutions to populate forms at the user-specific third parties, such as banks, brokerage accounts, insurance companies, title companies and public records databases. Computer programmable code allows the system to synchronize information with third parties and link assets to the user's estate plan by pulling information in from those third parties, including forms and designations made at those institutions.

One embodiment of the invention includes computer programmable code for allowing a user to transfer property and make ownership designations for liquid assets and real property, such as joint tenancy, tenancy in common or trust ownership and electronically effectuate the ownership changes by pushing these changes out to financial institutions or public records databases where title documents are recorded.

One embodiment of the invention includes computer programmable code for allowing a user to create a comprehensive estate plan, implement asset-by-asset planning, make designations related to trusts, and generate forms such as trusts, wills, medical directives, and powers of attorney. In one embodiment, computer programmable code generates a one-document estate plan with exhibits and allow for easier execution/notarization of documents and ultimately incorporating e-signing capabilities.

One embodiment of the invention includes computer programmable code for allowing the user to review his or her estate plan, add assets, make changes during life or after-death designations and assess the tax and insurance implications of his or her estate. In one embodiment, the system contains computer programmable code for valuing the assets of the user's estate and determining the tax implications as well as generating and auto populating the necessary tax forms that can be electronically transmitted to a user's tax vendors, accounts, or attorneys. In another embodiment, the system includes computer programmable code for triggering insurance recommendations based on the total estate value and types of assets in the estate, including insurance analysis and adjustments for vehicles, real property and other assets which may fall under an umbrella insurance policy. In one embodiment, the system may securely communicate electronically with third-party insurance agencies to retrieve forms, pull forms, or send data electronically to populate forms at third parties.

### DETAILED DESCRIPTION

The detailed description set forth below, about the appended drawings, is intended as a description of various configurations and is not intended to represent the only configurations in which the concepts described herein may be practiced. The detailed description includes specific details for providing a thorough understanding of the various concepts. However, it will be apparent to those skilled in the art that these concepts may be practiced without these specific details. In some instances, well-known structures and components are shown in block diagram form to avoid obscuring such concepts.

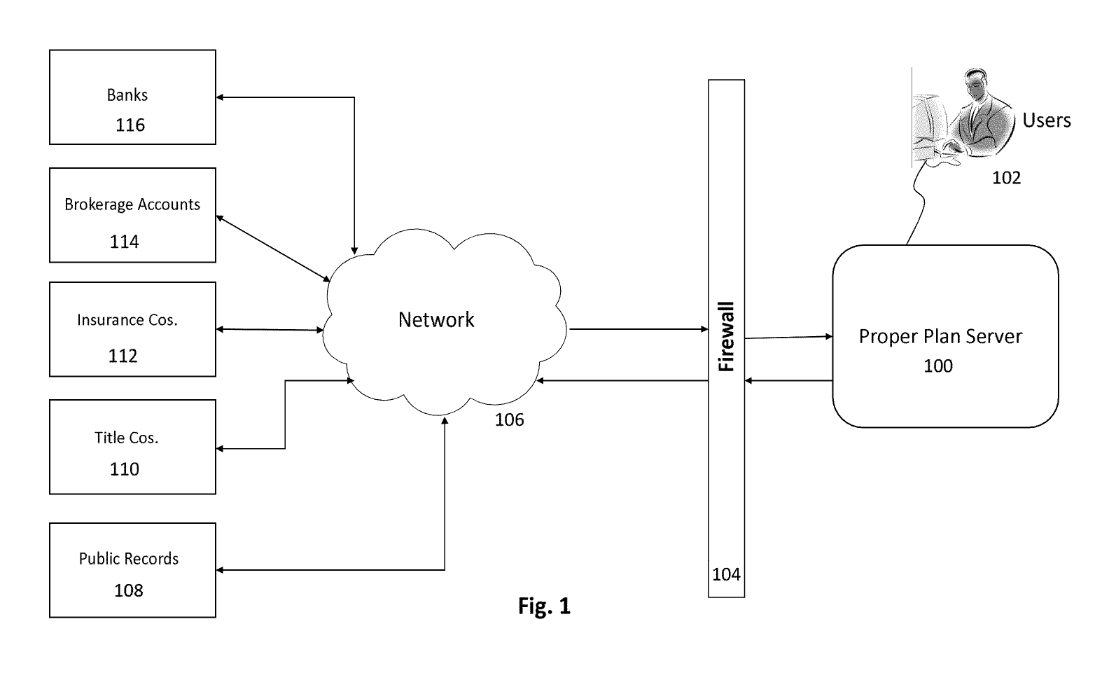

FIG. 1 depicts the network system architecture according to one embodiment of the invention. The system includes a proper plan server 100 which is the centralized estate planning server or network which hosts the software to effectuate the transfer of estate planning information across different networks and databases. A user 102 is shown logged into proper plan server 100 through a remote computer, which may include a desktop computer, laptop, tablet, smartphone, or any other suitable networked device capable of logging into the proper plan server 100 through an internet connection or other networked protocols known to one of skill in the art. In one embodiment, the proper plan server 100 is bi-directionally connected through a secure firewall 104 to a network 106 to various third-party institutions, including banks 116, brokerage accounts 114, insurance companies 112, title companies 110 and public records databases 108. The depicted system embodiment allows for the secure transfer of information between the proper plan server 100 and third-party institutions over communications means such as HTTP, HTTPS, and SSL. The communications may also be encrypted to protect sensitive financial information.

In one embodiment, the proper plan server 100 or an administrator may deploy automated bots and crawlers to search third-party financial institutions for digital estate documents and user identifying information related to a user's family, beneficiaries, properties, assets and other information relevant to creating a legally viable digital estate plan. In another embodiment, the proper plan server may deploy artificial intelligence algorithms to search for user identifying information and correlate such information with data that is statistically likely to match a user's preferences for beneficiaries, ownership, control and transfer of his assets.

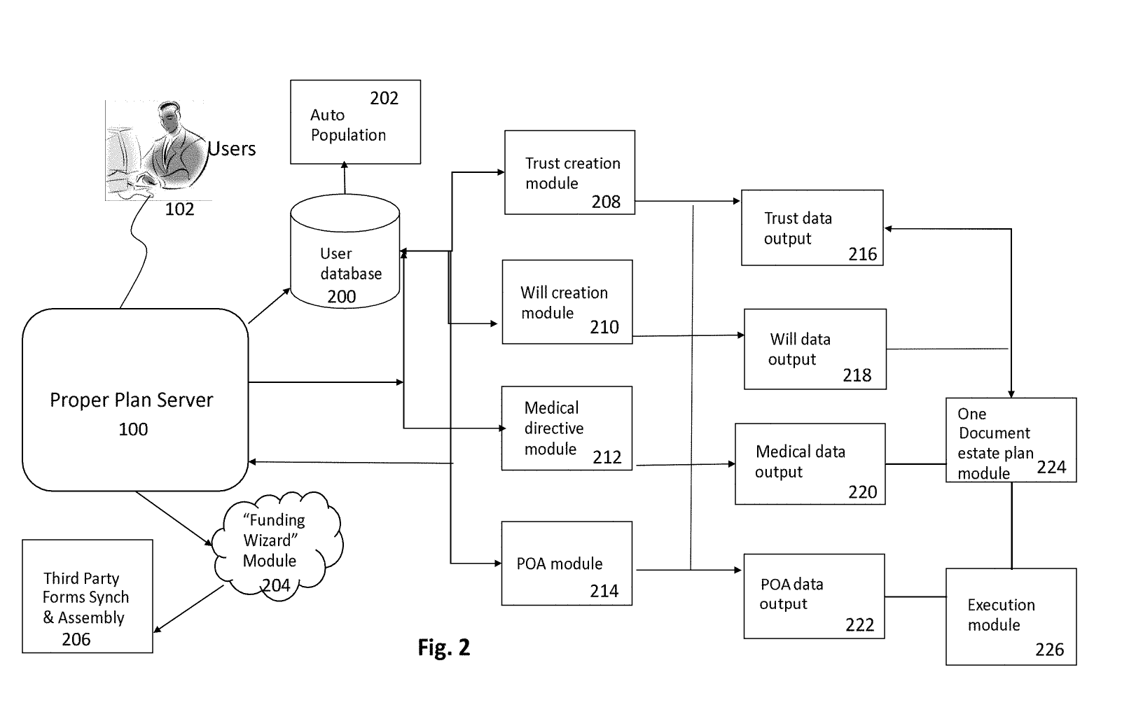

FIG. 2 depicts one embodiment of a computer implemented system architecture for creating an automated estate plan and one document estate plan. In this embodiment, user 102 is connected to the proper plan server 100. Once the user is registered with the proper plan server 100 and website and has selected from a menu of options for creating an estate plan, the user can enter information into online templates and digital forms that collect information necessary to effectuate an estate plan. User information and data is stored in user database 200. Information includes the user's banks, financial institutions, brokerage accounts, insurance companies, real property information and other information that is necessary to designate property in an estate plan. The user also enters information that is necessary to designate beneficiaries, heirs, trustors, trustees, and any other information that typically is provided to an estate planning attorney. In one embodiment, user database 200 can be auto populated into different forms and templates through the auto population module 202 so that the user does not have to enter the same information twice.

In one embodiment, the proper plan server 100 contains or is connected to various software modules that are programmed to create estate planning documents. For example, in embodiment, the trust module 208 retrieves or collects data from user database 200 to create trust data output 216. The will module 210 collects data from user database 200 to populate a template for the creation of will data output 218 which results in a will document. The medical module 212 populates data from the user database 200 to output a medical data output 220 for a medical directive form. The power of attorney module 214 collects data from the user database to output power of attorney data output 222. The modules 216-222 contain computer readable program code which enables the system to collect and process data from the user database and the auto population module 202 to create customized estate forms for the user.

In one embodiment of the invention, the system contains a one-document estate planning module 224 which synthesizes the pertinent information from a user's trust, will, medical directive output, and power of attorney output to create a one-document that captures all the essential information for the user and an estate planning attorney. This information includes the user's accounts, properties, beneficiaries, designees, trustors, trustees, and other essential information. In one embodiment, the system contains an execution module 226 which allows the user easily to schedule a meeting with a mobile notary to execute the one-document estate plan module and any other forms/documents in connection with financial institution and change of ownership and/or beneficiary designation. In another embodiment, the system contains an execution module 226 which allows the user to e-sign documents so that forms do not have to be printed out, as allowed pursuant to current/changing state laws on point. Once e-signed via the execution module 226, the documents can be saved, printed, or transmitted to a user's attorney or other estate planning professional.

In another embodiment, the funding wizard module 204 prompts the user to enter information on specific accounts and financial institutions such as the user's banks, brokerage accounts, retirement accounts, insurance companies, and other institutions where the user has property, assets, investments, or holdings. The proper plan server 100 and funding wizard module 204 then connects the user to third-party institutions and synchronizes information from the user database 200 to populate necessary forms, such as beneficiary forms, trust holding forms, power of attorney forms, co-ownership forms, and any other forms that are necessary to effectuate a proper estate plan. In another embodiment, the third-party synch and assembly module 206 retrieves the forms from the third-party institutions and asks the user to fill out templates to populate the forms at proper plan server 100. The process of retrieving and populating third-party forms can be automatic or semiautomatic.

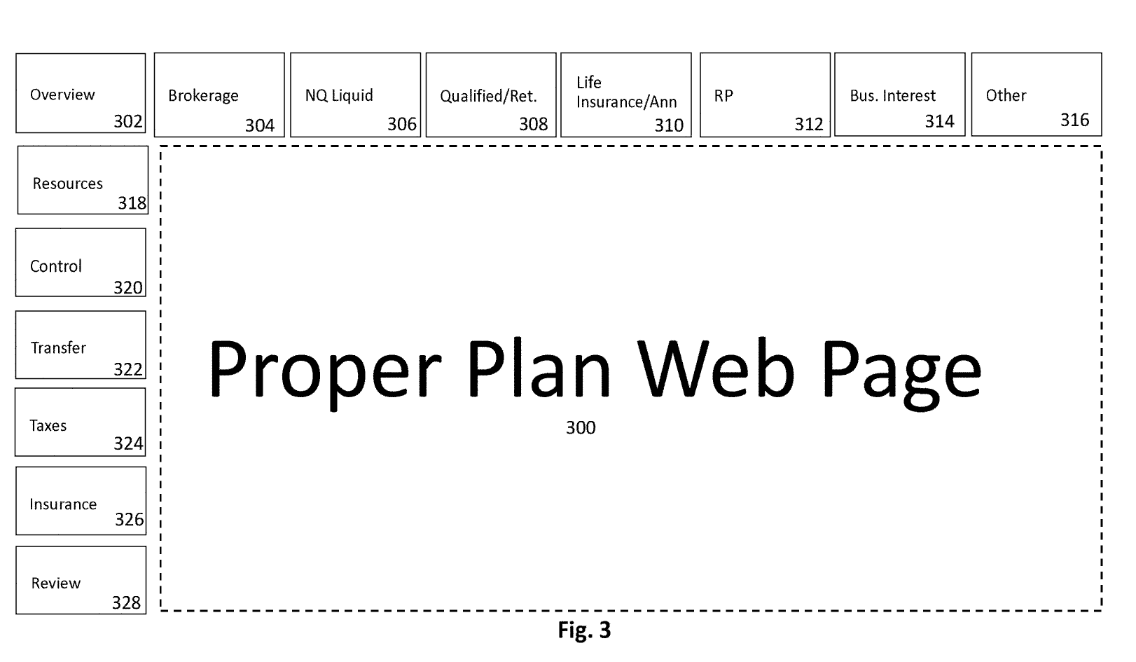

FIG. 3 depicts an embodiment of the proper plan web page (or GUI) 300 which can be at a local or hosted web server. The proper plan web page 300 has a menu of different GUI options which will be discussed in further detail in the accompanying drawings. At a high level, the proper plan web page may include on the x-axis, an overview tab 302, a brokerage tab 304, a non-qualified (NQ) liquid account tab 306, a qualified plan and retirement tab 308, a life insurance and annuity tab 310, a real property tab 312, a business interest tab 314, and other tab 316. Each of these sub-menus lead to different web pages, GUIs, and portals for providing information on a user's accounts, properties, retirement plans, insurance, annuities, real estate, and other holdings. In one embodiment, on the y-axis of the proper plan web page is included a resources tab 318 for links and information on resources to navigate through the proper plan web page; a control tab 320 for designating control, trustees, beneficiaries, powers of attorney; a transfer feature 322 for effecting transfer of assets; a taxes tab 324 for filling out and sending tax forms related to trusts, estate plans and probate; an insurance tab 326 for access to the user's insurance accounts or for obtaining insurance plans or information; and a review module 328 which provides a user a summary of the designations made and information added to the proper plan server 100 in order to assemble the user's electronic estate plan.

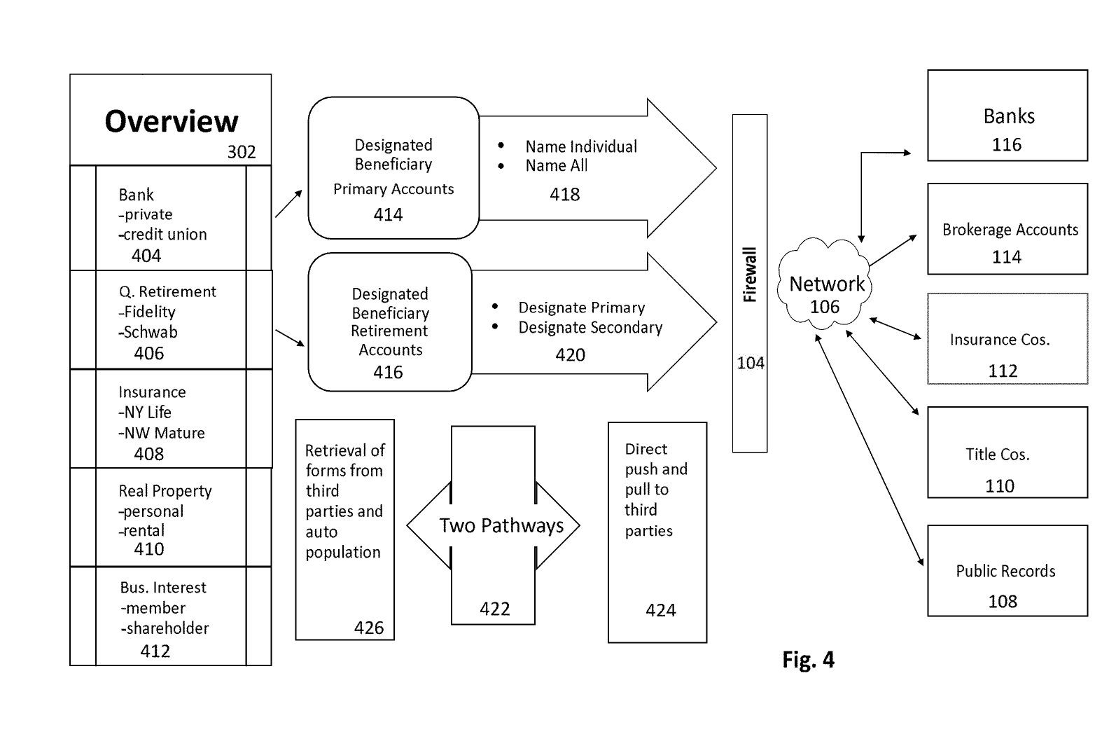

FIG. 4 depicts an embodiment of the overview tab 302 according to one embodiment of the invention. Under the overview tab 302, a user can designate information related to banks 404, qualified retirement accounts 406, insurance 408, real property 410 and business interests 412. In one embodiment, the user is then prompted to designate beneficiaries for primary accounts 414 where the user can then name individuals or name all the beneficiaries under prompt 418. Similarly, for retirement accounts, in one embodiment, the user may be prompted to designate beneficiaries under tab 416, allowing the user to designate both primary and secondary beneficiaries under menu 420. Similarly, this process can be carried out for the user's other accounts such as insurance 408, real property 410 and business interests 412.

FIG. 4 also shows how the overview system of the present invention interacts with third-party systems such as banks 116, brokerage accounts 114, insurance companies 112, title companies 110 and public records 108. There are two pathways in this embodiment by which a user can automatically or semi-automatically designate beneficiaries or other account information to effectuate the designations at third-party institutions 108-116. In one embodiment of the invention, the user designation of beneficiaries is made through an electronic push or pull system 424. In this embodiment, computer programmable code at the proper plan server can directly push the user's designations through the firewall 104 through network 106 to the individual user accounts at 108-116, thus automatically effectuating the designation of beneficiaries and other estate information at the third-party institutions. In another embodiment, the same information can be pulled directly by the third-party institutions 108-116 through a secure connection at the proper plan server 100. In another embodiment 426, the proper plan server 100 can retrieve the beneficiary and control designation forms from the third parties and auto-populate the forms based on data stored in the user database 200.

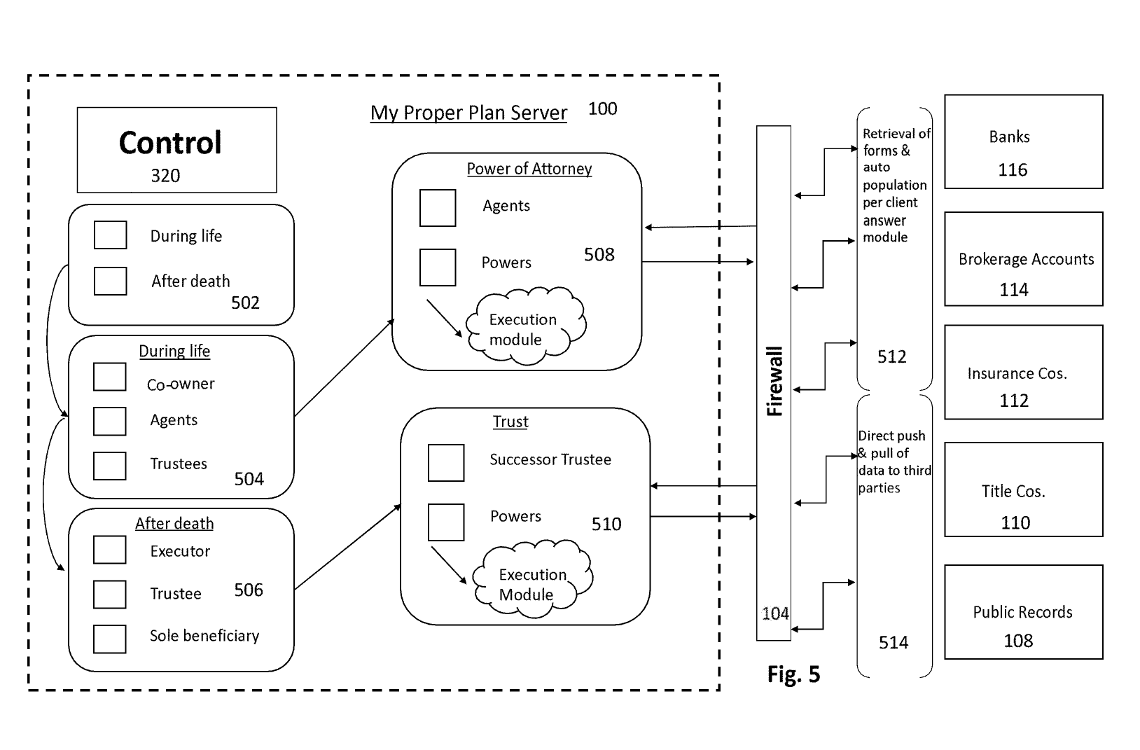

FIG. 5 depicts an embodiment of the control tab 320 of the present invention. Under one embodiment of the control tab 320 as embodied in computer programmable code in the proper plan server 100, the system allows you to specify during life and after-death 502 designations. If the during life feature 504 is selected, the user can specify co-owners, agents and trustees to his or her accounts and properties. If the after-death 506 feature is selected the user can specify an executor, trustee, and beneficiary. If an agent is selected, under during life tab 504 a user may be prompted by a power of attorney tab 508. In this embodiment, the user may select and designate agents, powers and utilize the execution module to easily arrange for the execution of the power of attorney forms. In another embodiment, the user may e-sign and e-notarize documents, as allowed per current state laws. In one embodiment, under the after-death tab 506, if a trustee is designated, a user may be prompted with tab 510 to specify further information on his or her trust, such as successor trustees and designated powers. Under the trust tab 510, the user can employ the execution module to e-sign forms related to trust designations. As with other embodiments of the present invention the control designations 320 made at the proper plan server 100 can be automatically or semi-automatically communicated to user's third-party accounts and institutions 108-116. In one embodiment, a direct push and pull module 514 is used to push information to the third parties or have those third parties pull the information securely through a firewall 104 from the proper plan server 100. In another embodiment, the form retrieval module 512 will retrieve forms from third parties and auto-populate the forms from data at the user database 200.

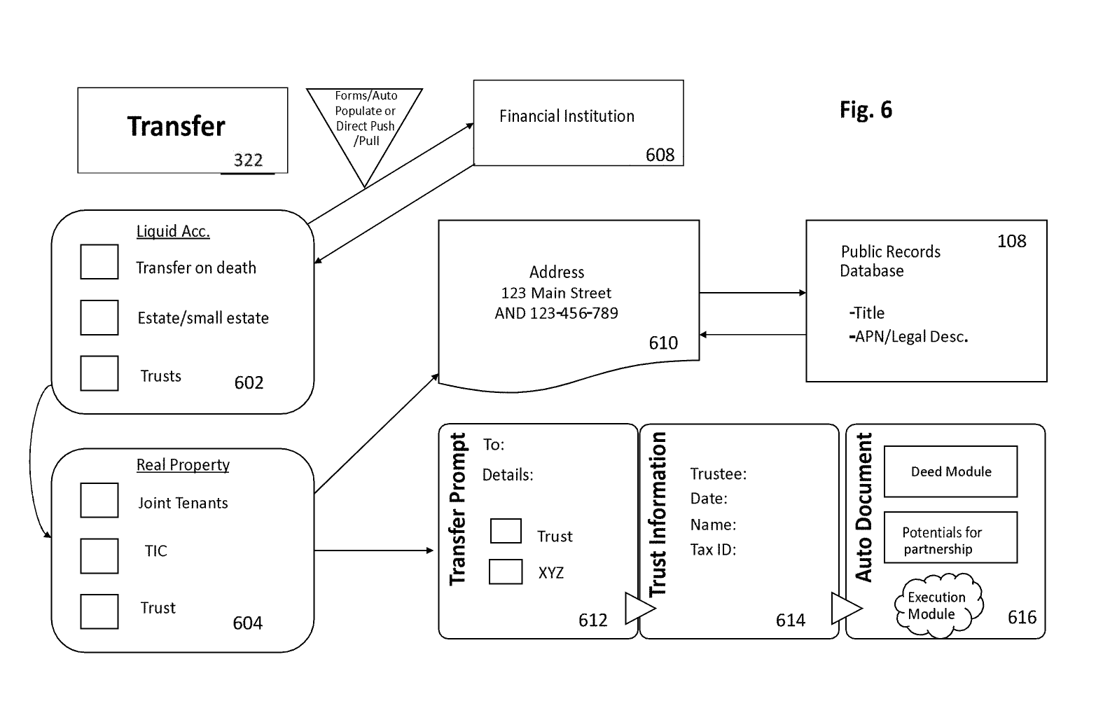

FIG. 6 depicts one embodiment of the transfer feature 322 of the present invention and its related interfaces. The transfer feature 322 allows a user to effectuate a transfer of properties during the life or after the death of the transferor. In one embodiment, the user's liquid financial accounts 602 prompts users with a menu of features to transfer-on-death or designate an estate or trust. These designations can be communicated electronically through the push and pull module to the user's financial institution 608 to record the user's selections. In one embodiment, under the real property tab 604, the user can specify ownership as joint tenants (JT), tenants in common (TIC) or put the real property in a trust. Under the real property tab 604, the process then moves to designate the address of the property 610 which can be verified by communication to a public records database 108. In one embodiment, the proper plan server 100 can automatically push the real property ownership designations to the public records database 108 to specify the legal description and ownership of the property which can be received and recorded in the public records database 108. In another embodiment, the public records database 108 can pull the information electronically from the proper plan server 100 to effectuate the auto population conveyance documents and assessor forms for the disposition of real property per the execution module. In another embodiment, when a user designates that the property should be held in the user's trust, a trust transfer prompt 612 is provided to the user where the user can fill out the details of the trust information 614, including a designation of the trustee, the date, name and tax identification number of the trust and other trust designation information. In one embodiment, the trust module 614 also prompts an auto-document feature 616 which includes a deed module and execution module. The deed module allows the user to send the trust designations to be executed on a deed document. In one embodiment, the execution module allows the user to quickly schedule a meeting with a notary to formalize the conveyance documents; in another embodiment, the execution module allows the user to e-sign the trust transfer document as allowed per local state laws.

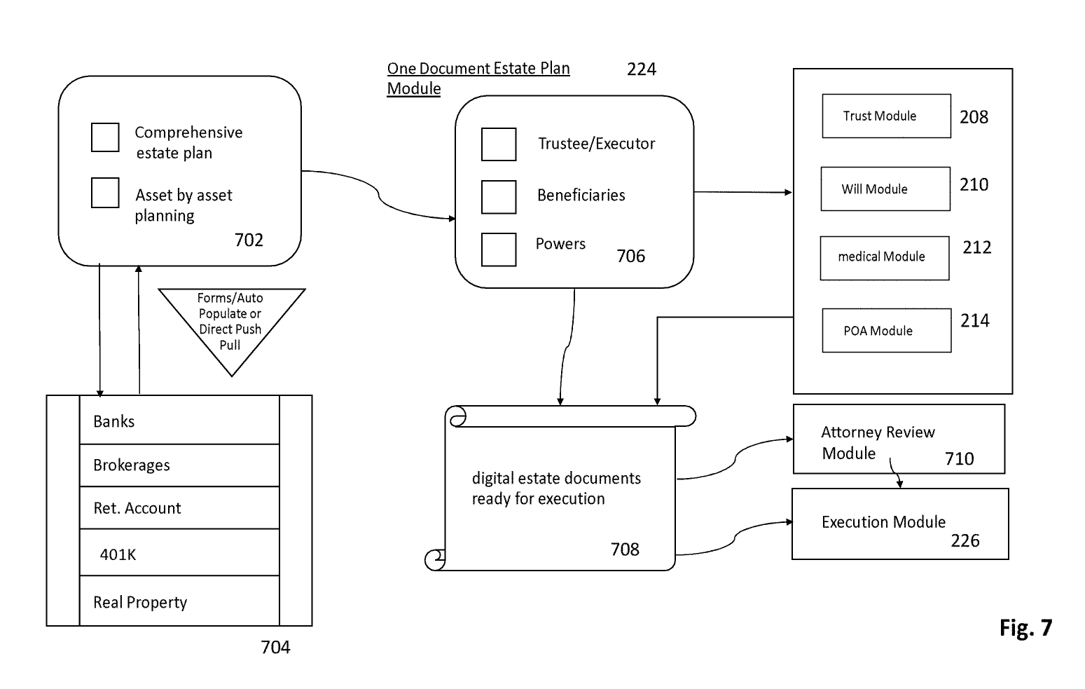

FIG. 7 highlights one embodiment of the one-document estate plan module 224. In one pathway at prompt 702, the user is prompted to choose between a comprehensive estate plan or asset by asset planning option. If the user chooses a comprehensive estate plan, he or she will be prompted at tab 706 to designate a trustee/executor, beneficiaries, and powers. In this process flow, the user can create a full trust, will, medical directive and power of attorney through use of the trust module 208, will module 210, medical module 212 and power of attorney module 214 which pulls information from the user's designation made through the comprehensive estate plan prompts and ready/relay to the one-document estate planning module. Once the user has made his or her designations and the estate planning modules have processed the user information, draft documents will be presented for the user for execution at step 708. In one embodiment, the user can select attorney review through an attorney review module 710 or go straight to executing the documents through an execution module 226. In one embodiment, if the user chooses an asset-by-asset planning process, in step 704, his or her designations will be pushed directly to third parties such as banks, brokerage accounts, retirement accounts, 401k accounts, and real property records. In one embodiment, these designations may be directly pulled through secure connections with third-party institutions to populate the necessary forms and send them back to the proper plan server 100.

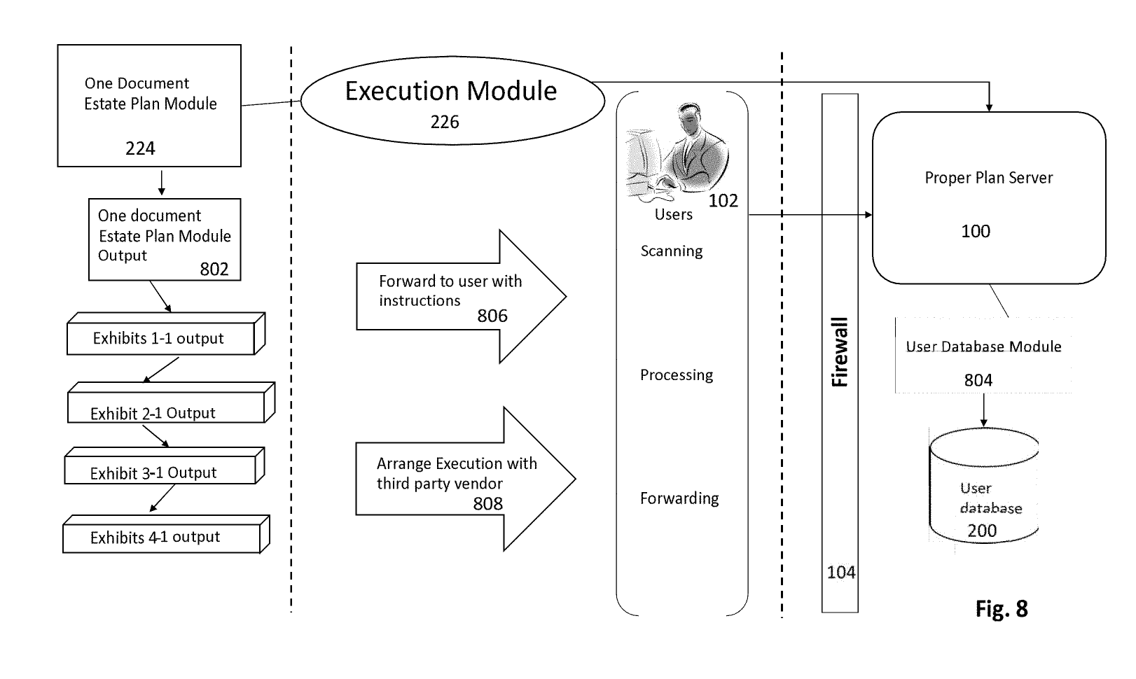

FIG. 8 depicts one embodiment of the process flow for the execution module 226 according to the present invention. In one embodiment, the execution module 226 communicates instructions to the one document estate plan module 224 to instruct the one document estate plan output module 802 which populates the user's estate planning information and designations into a single document. The one document estate output module 802 also generates exhibits 1-1 to 4-1, which include the user's full estate planning documents, including the user's trust, will, medical directive and power of attorney. Once the necessary forms are auto-generated by the execution module 226, thereby triggering the one document estate plan output module 802, the forms are forwarded to the user with instructions at step 806. In one embodiment, the forms can also be sent to a third-party for execution and notarization at step 808. The documents are then stored at the proper plan server 100 where the user database module 804 parses the information and stores it in user database 200. The execution module 226 allows the user to quickly execute and formalize the one document estate plan and ultimately allows the user to e-sign and generate all the final documentation for his or her estate plan which is then processed and stored at the proper plan server 100 and user database 200.

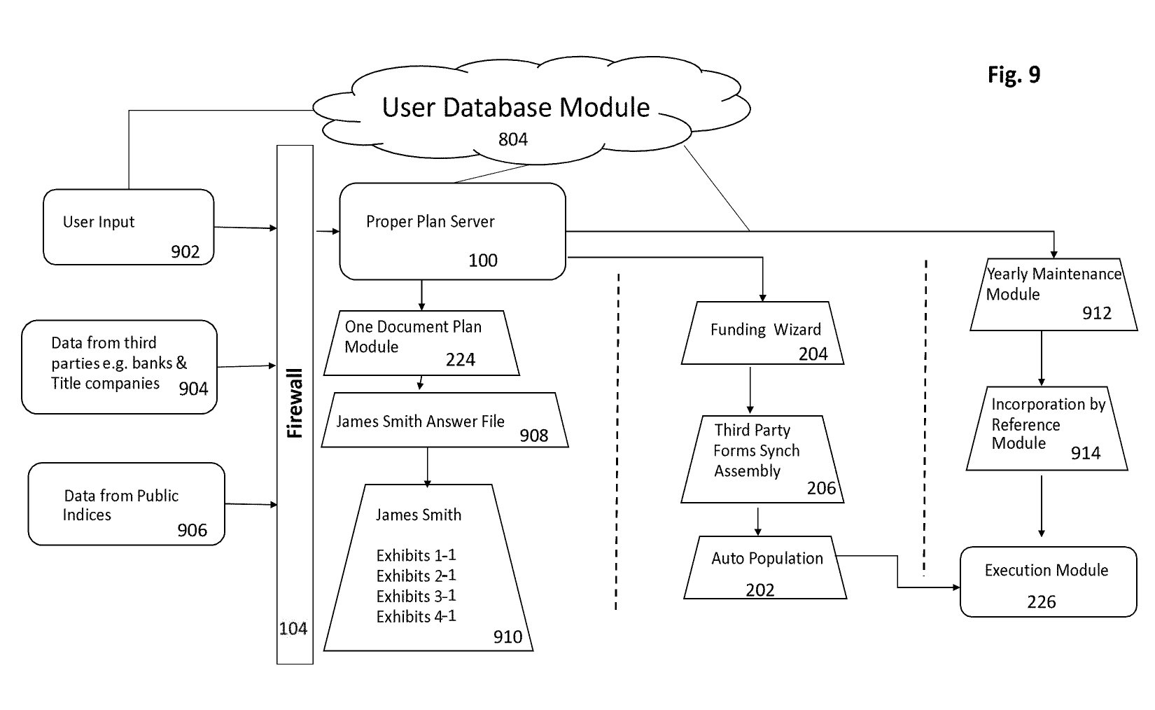

FIG. 9 depicts a system embodiment of the user database module 804 and its interaction with other software modules and databases at the proper plan server 100. The user database module may be a part of or separate from the proper plan server 100 or user database 200, where user estate planning information is stored. In one embodiment, the user inputs data at step 902, which as previously discussed, includes the control information, beneficiary designation information, trust information, power of attorney information and other information necessary to create an effective trust. In step 904 data from the user's third-party institutions, such as banks and title companies, is pushed or pulled into the proper plan server 100 using transfer protocols known to one of ordinary skill in the art. This may include information such as beneficiary designation forms, trust designation forms, joint or co-ownership forms or deed titles, insurance forms and any other third-party forms where the user has made lifetime or after-death designations for his or her property. In step 906 data from public indices, such as county recorder offices, is pushed or pulled into the proper plan server 100. In one embodiment, the one document module 224 and one document estate plan output module 802 assist a user in generating a one document estate plan at the user's answer file 908, including exhibits 1-1 to 4-1 which are stored in step 910 at the user database. In one embodiment, as previously discussed, the proper plan server 100 communicates electronically with the funding wizard module 204 which is responsible for communicating with third-party institutions such as the user's banks and brokerage accounts. The third-party forms sync assembly module 206 collects information from the third parties and works in conjunction with the auto population module 202 to generate the user's estate plan bank forms and exhibits. In yet another embodiment, the user can update his or her estate plan through the yearly maintenance module 912. Different plans for annual, biannual, or other specified time periods can be used by the user to update his or her estate plan. In this case, when the user selects a maintenance option through yearly maintenance module 912, the system invokes the incorporation by reference module 914 to incorporate by reference all the previous information, forms, and documents on file with the user and later updated exhibits with custom, limited powers of attorney granting proper plan server 100 power to update and maintain standard administrative and ministerial provisions of the estate plan. Once the user has updated their information, they are prompted to execute the updated estate plan via the execution module 226.

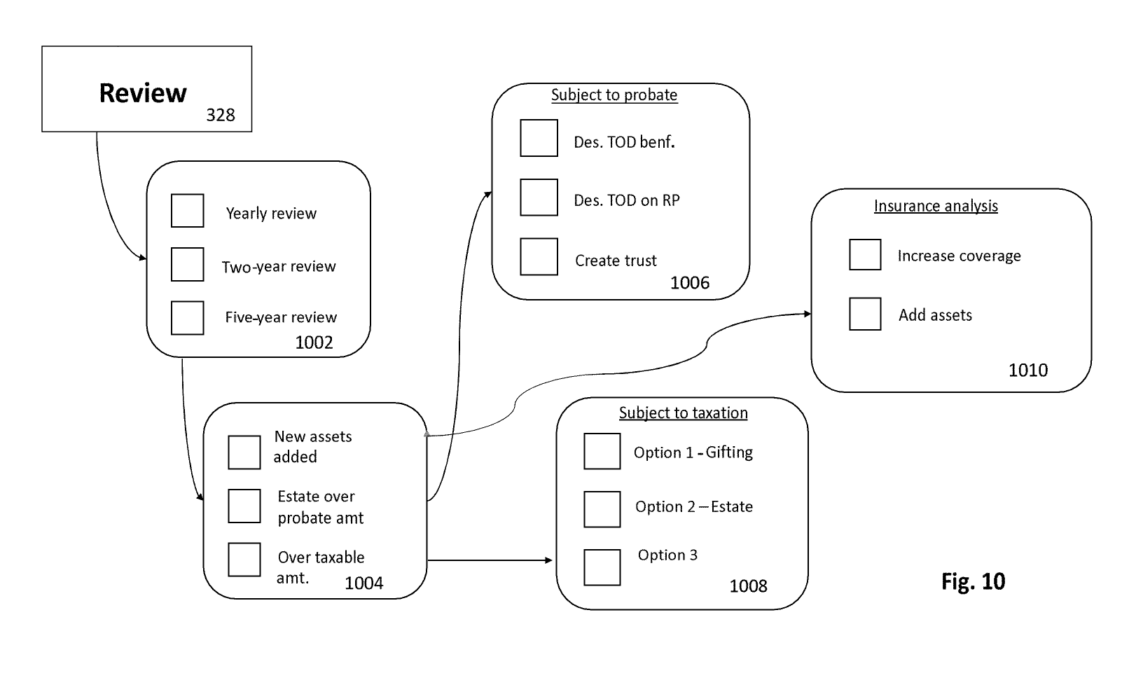

FIG. 10 depicts an embodiment of the review module 328 and related interfaces. The review module 328 allows the user to both finalize his or her estate planning documents, review other information such as insurance coverage and taxes and make other choices such as early gifting, increasing insurance coverage and making additional designations if recently added property creates an exposure to probate. In one embodiment, the review module 328 prompts the user to pick between a yearly review, two-year review, or five-year review plan at tab 1002. After the user has chosen an appropriate review option, he or she may be prompted at tab 1004 to select from option which include whether new assets have been added, whether the estate value is over the probate amount or whether the estate is over the taxable amount. If the estate is over the threshold probate amount, the user may be prompted at tab 1006 to make selections on his or her estate for amounts subject to probate. In this embodiment, at tab 1006, the user may designate transfer on death beneficiaries for accounts and for real property, or be prompted to create a trust. In one embodiment, if the property is over the taxable amount at tab 1004, the user may be prompted at tab 1008 to select from different options such as donating a certain amount of property, putting the property into a trust or making another selection which can help minimize the user's estate tax burden. If new assets are added at tab 1004, the user may be prompted to tab 1010 to make an insurance analysis and increase insurance coverage or add other assets.

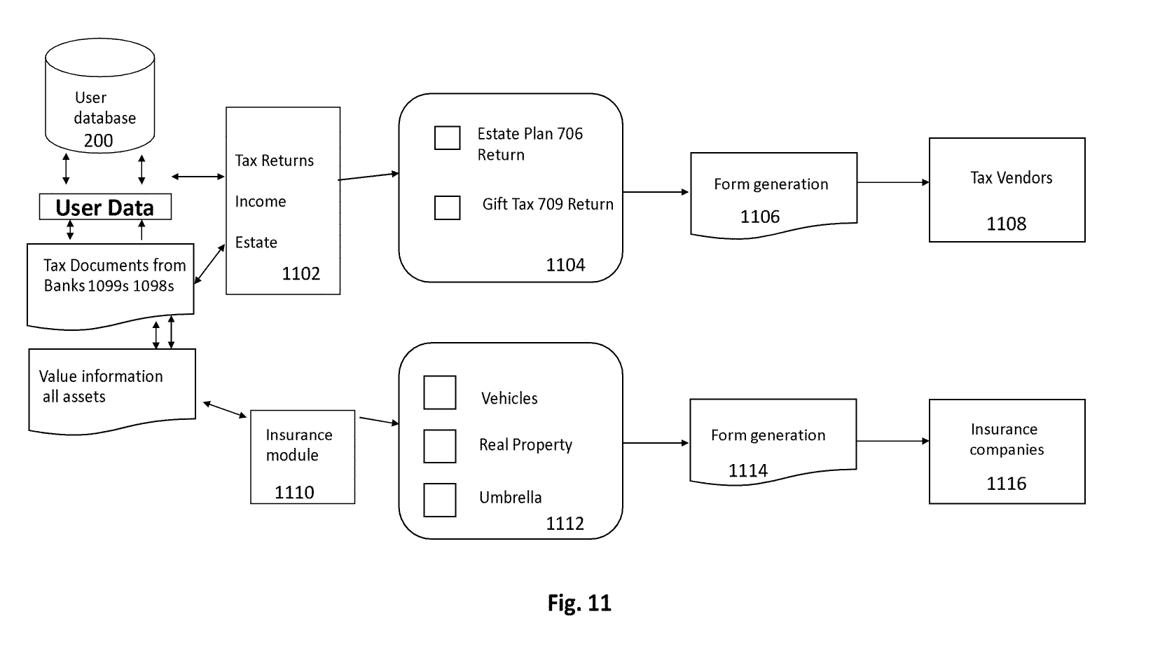

FIG. 11 depicts system embodiments of the tax and insurance modules of the present invention and related interfaces. In one embodiment, tax documents such as 1099s and 1098s are pushed or pulled by the proper plan server 100 into user database 200. In one embodiment, a tax return module 1102 prompts the user to tab 1104 where the user can select from various tax options including an estate tax 706 return or gift tax 709 return. Once the user has made his or her tax selections, form generation module 1106 may generate the appropriate tax forms for the user and send them to the user's tax vendors 1108, such as Turbo Tax, H&R Block, or another tax planning entity such as the user's tax lawyers or accountants. In one embodiment, the insurance module 1110 values the total amount of the assets in the estate. The user may then be prompted at tab 1112 to enter information on vehicles, property and other asserts that may fall within an umbrella policy. At step 1114, the user can generate a form summarizing the value of the estate's assets that can then be pushed securely to insurance companies 1116.

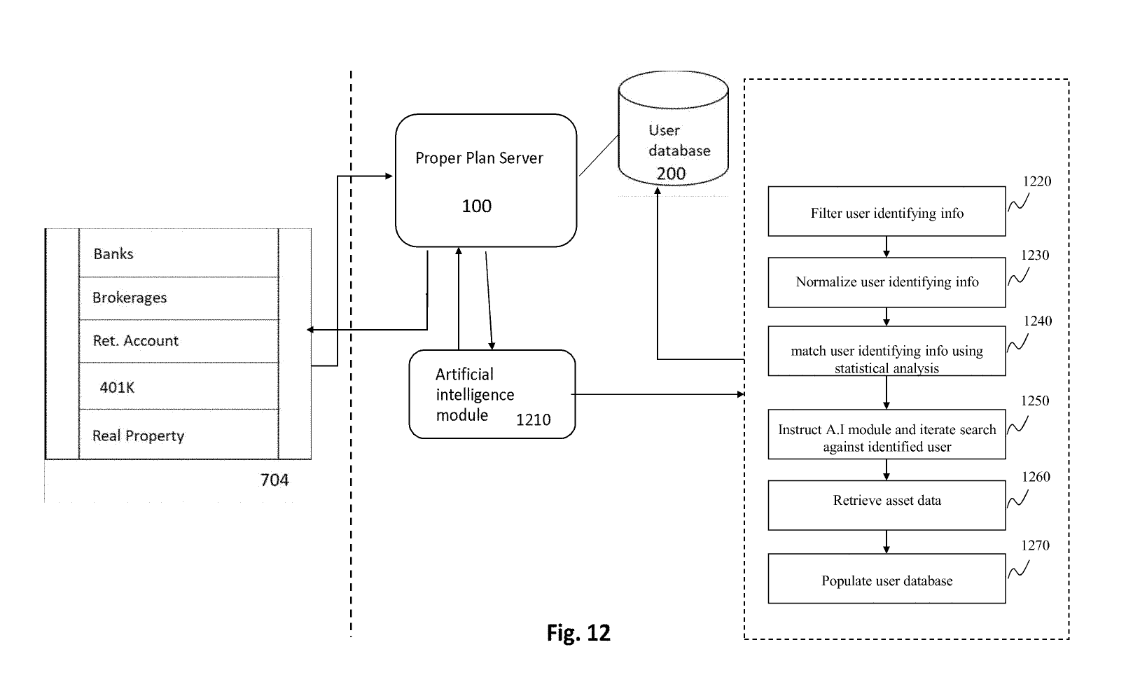

FIG. 12 depicts a computer and software implemented system and method for using artificial intelligence algorithms to retrieve user data and correlate such data into a user's digital estate plan. FIG. 12 depicts an artificial intelligence module 1210 which communicates with the proper plan server 100 to executive algorithms which retrieve user identifying information from financial institutions 704. The artificial intelligence module 1210 then executes a computer implemented method involving filtering the user identifying information at step 1220 for only relevant data, normalizing the user identifying information in step 1230 to eliminate repeat, redundant or irrelevant information, matching user identifying information in step 1240 with the correct user and relevant aspects of the user's digital estate plan, deploying the A.I. module to iterate the search against the correctly identified user in step 1250, retrieving asset information for the user in step 1260, and populating the relevant fields of an electronic database in step 1270. These steps need not necessarily be performed in order and the AI module can search, select and match data for the user and his asset information in any logical order.

One embodiment of the invention makes use of blockchain protocols to ensure that a user's financial data is secure. By storing data across its peer-to-peer network, the blockchain eliminates a number of risks that come with data being held centrally. The decentralized blockchain may use ad-hoc message passing and distributed networking. Peer-to-peer blockchain networks lack centralized points of vulnerability that computer hackers can exploit; likewise, it has no central point of failure. Blockchain security methods include the use of public-key cryptography. A public key (a long, random-looking string of numbers) is an address on the blockchain. A private key is like a password that gives its owner access to their digital assets or the means to otherwise interact with the various capabilities that blockchains now support. Data stored on the blockchain is generally considered incorruptible. While centralized data is more easily controlled, information and data manipulation are possible. By decentralizing data on an accessible ledger, public blockchains make block-level data transparent to everyone involved. Every node in a decentralized system has a copy of the blockchain. Massive database replication and computational trust maintain data quality. No centralized “official” copy exists and no user is “trusted” more than any other. Transactions are broadcast to the network using software. Messages are delivered on a best-effort basis. Mining nodes validate transactions and add them to the block they are building, and then broadcast the completed block to other nodes. Blockchains use various time-stamping schemes, such as proof-of-work, to serialize changes. Alternate consensus methods include proof-of-stake. Growth of a decentralized blockchain is accompanied by the risk of node centralization because the computer resources required to process larger amounts of data become more expensive.

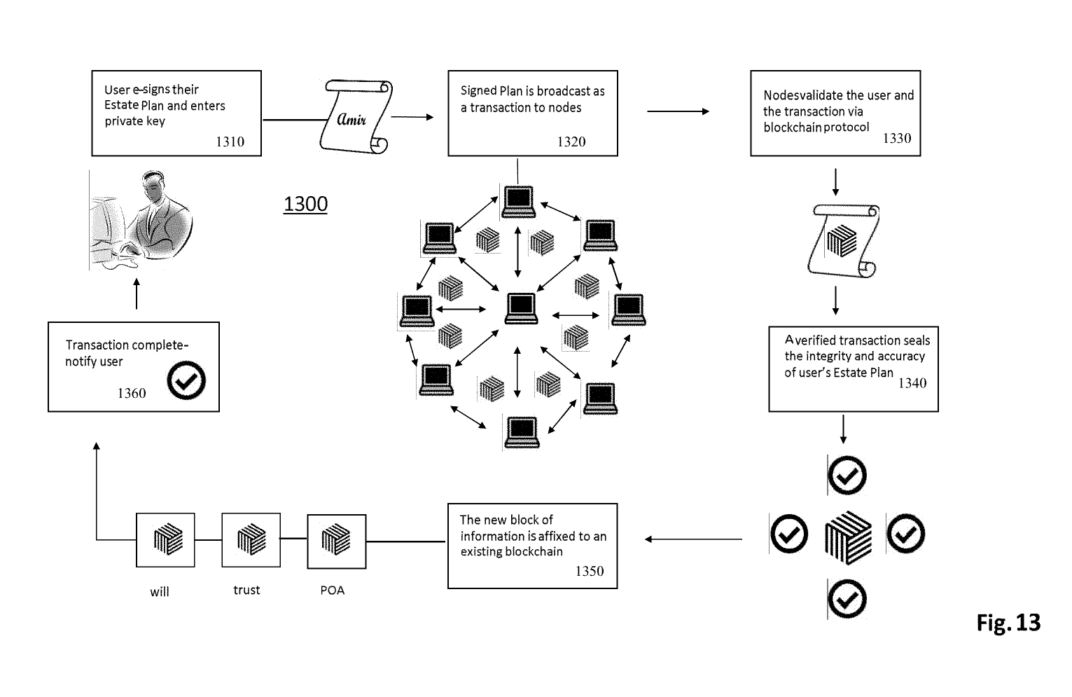

FIG. 13 depicts an exemplary blockchain system for effectuating a digital estate plan on a blockchain network. One embodiment of the invention utilizes blockchain protocols so that users can perform transactions without requiring the trust of anyone on the network. In step 1310, a user e-signs his estate documents and enters his private key. In step 1320, the signed estate plan is broadcast as a transaction to nodes on a blockchain network. In this embodiment, all estate documents and portions thereof are encrypted and the private data of the user is broken up into segments and stored across the blockchain network. Each time a new data record is fed into one of the nodes on the blockchain network it is broadcasted to all nodes in the network to get approved. In step 1330 the nodes validate the transaction using blockchain protocols known to one of ordinary skill in the art. In step 1340, when the digital estate plan transaction is approved, the record goes to a mining computer, which then verifies it and checks its accuracy. In step 1350, the user's estate documents, such as a will, trust, and POA is entered as a record into a block where it cannot be altered or deleted. In step 1360, the transaction is deemed complete and the user is notified.

Each user has his own private key, which is unique and impossible to manipulate. This private key is assigned to any transaction the user makes and serves as a personal digital signature. To validate the transaction, it is necessary that all peers on the network are approved, whether this signature matches the public key of the user's address. If the initial record is somehow altered, the signature will be invalidated and the peers will note it at immediately. Hence in this embodiment, the user can connect with the blockchain network for storage of John Smith's Last Will or Trust. Unlike other methods where confidential documents are stored on a third-party server, the legal documents are distributed across a blockchain network, where they cannot be accessed without the proper cryptographic credentials. And, when John Smith's will is actually updated, that update is captured in numerous blockchain nodes to verify that John Smith is the one updating his will or estate documents. In another embodiment, permissioned blockchain uses an access control layer at proper plan server 100 to govern who has access to the network. In contrast to public blockchain networks, validators on private blockchain networks are vetted by the network owner at proper plan server 100.

In another embodiment, the proper plan server 100 uses various APIs (Application Programming Interfaces) to connect with a number of third-party databases using artificial intelligence algorithms that will analyze user identifying information and link and correlate user information to public and private databases that are likely to have information to populate user database 200. For example, a user's profile data may include information concerning their real property and property addresses. Based on this information, the proper plan server 100 can execute an API to connect to various third-party real estate applications such as Zillow, which can gather data such as the market value of the property. This information can be pulled from Zillow and populated into the user database 200. The proper plan server can also analyze the user's real property information and execute API that connect to various government databases to access to specific identifying information about real property (legal description, assessor parcel number, grantee/grantor index).

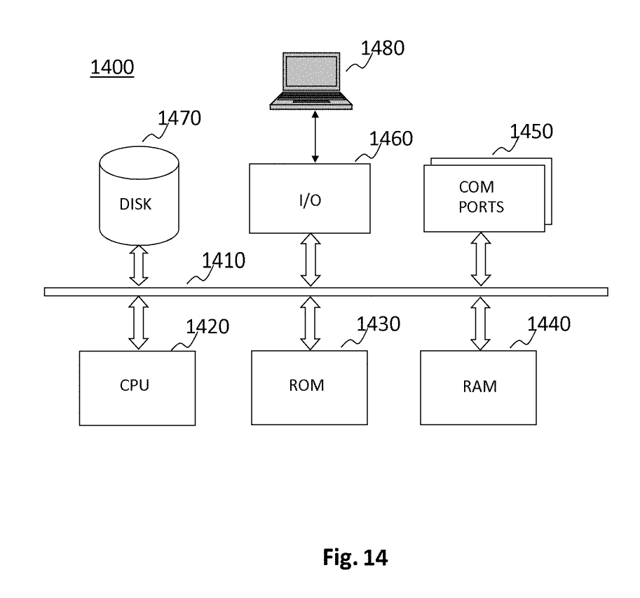

FIG. 14 depicts an exemplary computer architecture 1400 for implementing the software and computer code instructions pursuant to the described embodiments herein. 1410 depicts a bus, 1440 depicts a CPU, 1430 depicts storage media such as ROM, 1440 depicts memory such as RAM, 1450 depicts COM ports, 1460 depicts input and output (I/O) interfaces, 1470 depicts a disk device, and 1480 depicts a user computer terminal. The various computer implemented aspects of a computing device described in connection with the disclosure herein may be implemented or performed with a processor shown as CPU 1420, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

At least some aspects of the methods described herein may be embodied in programming. Program aspects of the technology may be thought of as “products” or “articles of manufacture” typically in the form of executable code and/or associated data that is carried on, embodied in, or physically stored on a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

Those of skill would further appreciate that the various computer instructions or methods in connection with the disclosure herein may be implemented as electronic hardware, computer software, or combinations of both. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, data drive dynamic logging system and its components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A computer system embodied in computer readable storage medium for automating a digital estate plan, comprising:
a GUI for collecting user identifying information across a user's assets;
computer code for executing an application to retrieve said user identifying information and populating a database with said user identifying information;
computer code for retrieving said user identifying information from said database and correlating said user identifying information into electronic fields of digital estate forms;
computer code for reformatting said user identifying information and populating electronic fields of third-party digital forms;
computer code for generating a digital estate plan comprising digital estate documents and completed third-party digital forms.

2. The system of claim 1 wherein the assets are selected from the group consisting of banks, brokerage accounts, real estate properties, insurance policies and personal property

3. The system of claim 1 further comprising a centralized server executing a trust creation software module, a will creation software module, a medical directive software module and a power of attorney software module

4. The system of claim 1 where said user identifying information across a user's assets is automatically retrieved through an authentication process with third-party databases

5. The system of claim 1 further comprising computer code for analyzing said user identifying information and retrieving the third-party electronic forms corresponding to the institutions holding the user's assets

6. The system of claim 1 further comprising computer code for efficiently allocating computer resources by using artificial intelligence algorithms that gather user identifying information across the user's assets from multiple databases to minimize the manual entry of data into electronic fields

7. The system of claim 1 wherein the user's digital estate plan is transmitted and stored on a blockchain network.

8. A computer implemented method executing computer readable media for automating a digital estate plan, comprising the steps of:
authenticating a user by processing digital identification data;
connecting said user to a server;
executing a GUI for capturing the user's asset information across multiple asset sources;
executing a GUI for recording a user's preferences for asset distribution;
retrieving electronic forms corresponding to the user's assets from third-party servers;
parsing said user asset information and auto-correlating said information into electronic fields of digital estate documents and third-party digital forms;
generating a digital estate plan comprising digital estate documents and completed third-party digital forms

9. The method of claim 8 wherein the electronic estate documents are selected from the group consisting of a will, trust, medical directive, and power of attorney.

10. The method of claim 8 wherein a portion of the user's asset information is auto-populated into a database using artificial intelligence algorithms to correlate user data with asset sources identified with the user.

11. The method of claim 8 further comprising the step of generating graphical user interfaces for specifying the transfer, control and disposition of the user's assets.

12. The method of claim 8 further comprising the step of executing an internet crawler or bot to retrieve third-party digital forms corresponding to the user's assets.

13. The method of claim 8 further comprising the step of executing an application programming interface for securely transferring the user's preferences to third-party databases for populating third-party digital forms.

14. The method of claim 8 further comprising the step of storing the user's digital estate plan on a blockchain network.

15. The method of claim 8 further comprising the step of calculating the user's taxes in connection with the user's digital estate plan.

16. The method of claim 8 further comprising the step of auto-updating the user's asset information based on changes to the user's asset classes and ownership.

17. The method of claim 8 further comprising the step of automatically notifying the user by electronic means when a condition occurs that affects the user's preferences for asset distribution.

18. The method of claim 8 further comprising the step of calculating an insurance recommendation based on a valuation of the user's assets.

19. Computer readable media having program code recorded thereon for execution on a computer for displaying an interactive script for a digital estate plan, comprising code for:
generating a GUI for capturing a list of assets from a user by executing interfaces that prompt a user to provide user identifying information for assets across different asset classes;
generating a GUI for capturing user data related to a user's beneficiaries by executing interfaces that prompt the user to correlate beneficiaries with different asset classes;
generating a GUI for capturing user data related to control features for the user's assets by executing interfaces that prompt the user to appoint agents;
generating a GUI for capturing user data related to transfer features for the user's assets by executing interfaces that prompt the user to make selections concerning transfer of assets;
generating an execution module for auto-correlating user information captured from said GUIs into electronic fields corresponding to a digital estate plan

20. The computer readable media of claim 19, further comprising code for securely retrieving information on a user's assets from third-party servers for auto-correlating user information into electronic fields corresponding to a digital estate plan.
